(19) United States
(12) Patent Application Publication
(10) Pub. No.: US 2006/0287936 A1
(43) Pub. Date: Dec. 21, 2006

(54) Subodmain name marketing

(76) Inventor: Clifford R. Jacobson, Rochester, NY (US)

Correspondence Address: HISCOCK & BARCLAY, LLP, 2000 HSBC PLAZA, ROCHESTER, NY, 14604-2404, US

(21) Appl. No.: 11/446,071

(22) Filed: Jun. 2, 2006

Related U.S. Application Data
(60) Provisional application No. 60/687,071, filed on Jun. 3, 2005.

(51) Int. Cl. G06Q 40/00; G06F 15/16

(52) U.S. Cl. 705/35; 709/203

(57) ABSTRACT

A method for identifying an item or service for sale or distribution as a subdomain on a primary domain owned by the operator of the invention, assigning the subdomain name as determined by the buyer or lessor of the subdomain. A primary domain name of the operator is used as a classifying base, and adds subdomain names with unique identifiers for the item. Once such subdomains are assigned and in use, they may be accessed by searchers who are prospective browsers and buyers. When the unique identifier, such as the street address of a property, is entered into a search engine, the search engine directs the searcher to the subdomain of the operator. The invention secures a unique domain name and corresponding web site with subdomain web pages for the item. It customizes the web pages for each property with particular information about the item, and includes pre-packaged related information about buying and selling items and advertisements by ancillary vendors. By its use of subdomain names with unique domain names in specific markets, the invention disintermediates commerce by facilitating direct connections between sellers and buyers, and disintermediates online shopping by avoiding the biases of commercial search engines.

### CROSS-REFERENCE TO RELATED APPLICATION

This application claims the benefit of the priority date of U.S. Provisional Patent Application Ser. No. 60/687,071 filed Jun. 3, 2005.

### FIELD OF THE INVENTION

This invention is related to advertising and promotion, and more specifically to advertising and promotion on the World Wide Web.

### BACKGROUND OF THE INVENTION

Advertising on the World Wide Web presents unique challenges. In real estate, a homeowner wishing to advertise a home for sale or rent is faced with many restrictive options on how and where to advertise. In selling automobiles, boats, or other large goods, the same problem arises. In posting events such as weddings or celebrations of any kind, finding an appropriate and adequate medium for the posting can be difficult. In all these situations, and in many others, advertisers face significant obstacles in distinguishing their offered goods and services from those of millions of other people and businesses.

As many as one sixth of all home sales in the US are made without a licensed broker. Such homes are commonly referred to as “for sale by owner” or FSBO homes. FSBO sellers use various techniques to market their homes including services provided by FSBO marketing companies that list homes for sale in newspapers and provide sellers with lawn signs.

Real estate agencies would like to tap this market but their current techniques are poor to abysmal. In a typical agency the job of contacting the FSBO is given to entry level sales agents who make cold calls to FSBOs to solicit the FSBO to list with the agency. This is a difficult and often fruitless assignment. The FSBO seller already made a decision to not use a listing broker and often feels the caller is pestering him.

Other tedious tasks are also assigned to trainees. These tasks include reviewing published lists of expired real estate listings. If a listing expires, it is possible for a new broker to call on the property owner and solicit the owner as a listing agent.

Most of the above activities are performed manually by multiple agents in training at different real estate agencies. There is a wide duplication of tedious effort. Thus, there is a need to reorganize such efforts, use the World Wide Web and computing power to remove the tedium from the tasks and provide a streamlined marketing method and apparatus for marketing real estate and other properties or services.

### SUMMARY OF THE INVENTION

Homes, autos, patents, personal property, and services are often associated with a unique identifier, such as the street address, telephone number or a serial number that is owned or controlled by the owner or seller of the property or service. The invention identifies the item or service for sale or distribution as a subdomain on a primary domain owned or operated by an individual or business entity. The owner/operator may manually or automatically assign subdomain name as determined by the buyer or lessor of the subdomain.

If the identifier is used as the primary domain, then each item or service would have to be individually registered as a domain name, which would be both cumbersome and expensive. Instead, the invention uses a primary domain name of the operator as a classifying base, for example, YourProperties.com for real estate or YourCars.com for autos, and adds subdomain names with unique identifiers for the property, for example, 755 ParkAve.Rochester.NY.YourProperties.com or 1979VintageMustang.DallasRestorers.YourCars.com. Once such subdomains are assigned and in use, they may be accessed by searchers who are prospective browsers and buyers. When the unique identifier, such as the street address of a property, is entered into a search engine, the search engine directs the searcher to the subdomain of the operator.

The invention secures a unique domain name and corresponding web site with subdomain web pages for the property. It customizes the web pages for each property with particular information about the property, including pre-packaged related information about buying and selling homes and advertisements by ancillary vendors such as lenders, real estate attorneys, home inspectors and home repair contractors.

By its use of subdomain names with unique domain names in specific markets, the invention disintermediates commerce by facilitating direct connections between sellers and buyers, and disintermediates online shopping by avoiding the biases of commercial search engines.

### BRIEF DESCRIPTION OF THE DRAWINGS

FIG. 1 is a system diagram of how the invention operates with the Internet and the World Wide Web as well as mobile devices.

FIG. 2 is a diagram of key steps of the invention for the real estate realm.

FIG. 3 is a diagram of key steps of the invention for a general commerce realm.

FIG. 4 is a system diagram of the automated creation of subdomains from received data using various sources.

FIG. 5 is a system diagram of meta searching for providing targeted advertising based on temporal and other references using advertising metadata.

### DETAILED DESCRIPTION OF THE INVENTION

The description which follows illustrates the invention and its operation in the realm of real estate. The invention operates equally well in any other realm in which names of items and classes of items may be mapped onto the names of subdomains in a computer network.

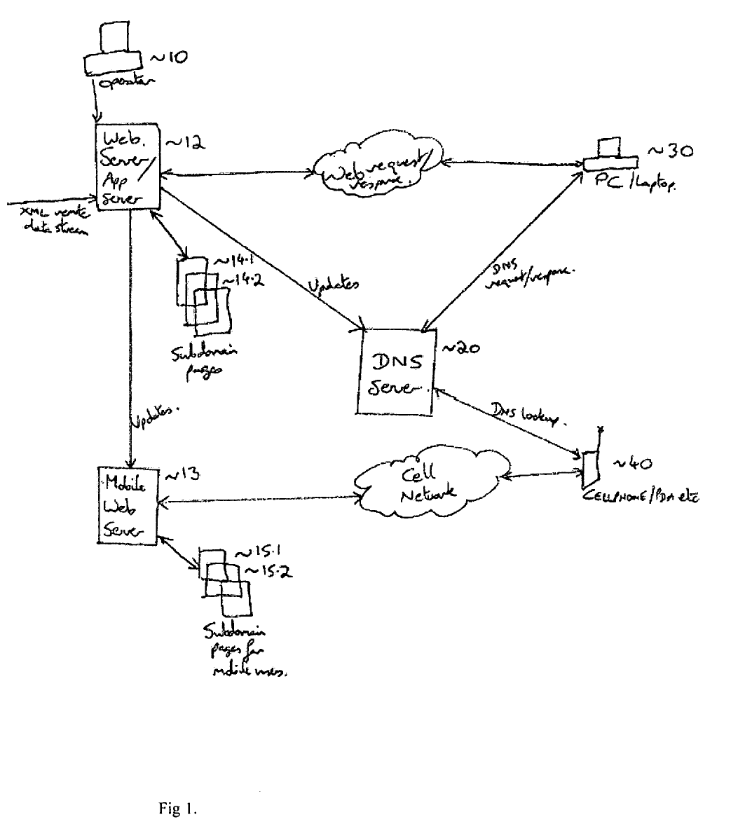

With reference to FIG. 1, an operator at a computer 10 establishes a domain name with a registrar of domains such as Network Solutions or any other registrar service. For heuristic purposes, the following description refers to an “operator” who may be either an individual human being or may be computer program that operates automatically or a combination of some manual operation and other automatic operation. Once the domain name is secured, the operator establishes a Web site for the domain name at a hosting service using a web and application server 12. Let us assume for the purpose of explaining the invention that the operator chooses the domain name Clifford.com. Of course, the operator may provide his or her own computer or server to host the web site. However, when one expects to receive numerous visits, it is usually better to contract with a professional hosting service to provide access to the domain by visitors.

Once the domain name is established, the operator 10 uses the server 12 which adds multiple subdomains 14.1, 14.2, . . . 14.n to provide a subdomain for each property or service offered for sale using a DNS server 20. For example, one subdomain 14.1 may be used for 123 Maple Street, Rochester, N.Y. 14614 will have a two-part address: a subdomain for the property and the primary domain of the operator, e.g. 123maplestreet14614.Clifford.com. Notice that the subdomain is separated from the primary domain by a period that appears between “4” and “c.” As an alternative, the address could be 123maplestreetrochestemy.Clifford.com. Thus, the address has three parts: the subdomain (123maplestreet14614), the primary domain (.Clifford) and the highest level domain (.com). The address of Clifford.com is then indexed on the Internet via the World Wide Web search engines. The server 12 automatically generates subdomain pages for mobile users 15.1, 15.2 . . . 15.n using a push model to send the pages to the mobile web server 13. Cellphone and other mobile devices 40 can then access these pages on the mobile web server 13.

Once the domain is indexed and its subdomains established, one or more users 30 can view the web pages at Clifford.com by accessing the site www.Clifford.com or by going directly to individual pages on the site, such as 123MapleStreet14614.Clifford.com. As mentioned above, the owner of the property may receive a limited right to access and edit the Web pages that correspond to his/her property. For example, an owner may be permitted to post text or images or both about the property or other items, such as family history, improvement they made to the house, etc.

The primary domain and each subdomain are used to generate advertising revenue. Locations on the web pages may be leased to one or more ancillary vendors, such as real estate agents, attorneys, lenders, home inspections services, home repair services, appliance stores, etc.

In operation the operator takes a first step 110 to identify properties in a given region or market segment. For example, the operator may select all properties in a village, town, city, state, collection of states or the entire country. Next, the operator selects a primary domain, such as Clifford.com. The address for the primary domain is, for example, www.Clifford.com.

Once the primary domain has been secured, any number of subdomains may be added to the primary domain at little or no extra charge. The server then adds subdomain names for each property identified and generates or updates existing index files. This is step 120. Those skilled in the art understand that selection of subdomain names may also be automated so that an address field in data may be selected and incorporated into a subdomain name. Such data may be pushed or pulled in the web site. Here the operator enters such unique subdomain names that correspond to the address of the property or the subdomains can be automatically generated. For example, if one of the properties has a street address of 123 Maple Street, Rochester, N.Y. 14614 the operator may choose a subdomain name of 123MapleStreetRochesterNY. As an alternative, the operator may use the ZIP code and shorten the subdomain name to 123MapleStreet14614. Many localities have streets with similar names, such as Maple Street, Main Street, State Street, Broadway, etc. These ubiquitous street names are nevertheless unique in each locality. In other words, there is only one Maple Street in a given town. Likewise, there is only one Maple Street associated with a given ZIP code.

After the subdomain names are created then web pages at the main site may be populated with images, information and advertisements. In a subsequent step 130 the operator populates the subdomain site with images and information about the property. The images may be supplied by the owner or may be taken from a web site of a co-broker. Likewise, details of the property including the lot size, type of house, its construction, its living area, number and type of rooms, number of baths, school district and further information is also added to the site. Such information may be provided by the owner of the property or may be publicly available or made available from another web site of a co-broker.

In a preferred embodiment, the site is further populated with material or links or both that directs a visitor to detailed relevant information about buying and selling a house. Many marketing agencies provide information about how to prepare a house for sale, what factors improve the likelihood of selling, etc. This information is added to the site in the form of other web pages, or is made available by a link to the site where the original information appears. Other links may be provided to information about the state, county and city, town or village and information about the local school district associated with the property, the history of the community, etc.

As explained above, one of the primary applications of this method is marketing homes that are for sale by the owner. Accordingly, the operator of the site enlists the owner's help in popularizing the site by offering the owner a limited right of access to the site. See step 150. With this limited right, the owner of the property may post further images and details of the property that are not part of the general or standard property listing. For example, if the house is offered for sale in the winter when there is little foliage, the owner may choose to post pictures of the house taken during a prior spring, summer or fall. The owner could also post other information about the house or the neighborhood or the town, the owner's family and even the owner's opinions.

The operator may also make the site available to agents who are ancillary to buying and selling a home, including and not limited to mortgagees, lenders, banks, credit unions, savings and loan associations, mortgage brokers, lawyer who concentrate in real estate law, real estate agents, building inspectors, pest inspectors, chimney inspectors, and others. This step is step 160.

The properties selected by a given operator may also fall into distinct market niches. Those separate niches are identified in step 140. There the operator may identity properties listed for sale by owner, or properties whose listings with an agent have expired. Rental properties are another candidate.

A more detailed operation of the invention includes one or more of the following steps:
1. Target a market or a submarket, such as FSBOs, new MLS listings, new construction, foreclosures, auctions, sale pending sale completed or a submarket thereof (e.g., FSBO by price or location) in a given geographic area such as a Multiple Listing Services (MLS) area.
2. Get a list of all addresses of the chosen market or submarket from other sources including where available such source for sale by owner marketing companies or MLS subscription companies, newspapers and internet listings.
3. Generate unique subdomain names that identify the FSBO properties, such as 123maplestreetrochesterny.domain.com or 123maplestreet[latitude][longitude].domain.com., or 123maplestreet14614 where the last five numbers are the ZIP code that is unique to the property located at 123 Maple Street in the City of Rochester, N.Y.
4. Register a domain name and establish subdomains for the FSBO properties and open Web sites using the subdomain/domain names such as 123maplestreet14614.Cliffordrealty.com where Cliffordrealty.com is a primary domain name and 123maplestreet14614 is a subdomain of the primary domain.
5. Populate the individual web pages for each subdomain with particular information about the FSBO property. The information may be gathered from one or more public resources (see step 2 above) including, for example, square footage, lot size, location, taxes, school district, number of rooms, pictures, and other information relevant to the property.
6. Populate the subdomain web pages with pre-packaged content relevant to selling property or links to other sites that have such information.
7. Sell advertising space on the subdomain web pages to vendors associated with real estate transactions, such as mortgage brokers, home inspectors, lawyers, insurers, contractors, movers, etc. Include hyperlinks to the advertiser's web site.
8. Include a prominent ad and hyperlink for the owner or operator of the primary domain name.
9. Include hyperlinks to other property listings, such as listings of the operator of the primary domain name or listings of co-brokers. (e.g. “If you liked this property, see these similar properties: 1, 2, . . . ).
10. Perform research on the owner/seller to gain information about his or her background, likes, dislikes, family, education, profession, etc. in order to understand the individual as much as one can from available public sources of information, e.g., professional listings, personal web sites, etc.
11. Populate a customer profile form with the information gathered in the prior step for use in instructing sales agents about contacting the potential customer.
12. Train sales agents to contact the customer by instilling a desire in the sales agent to take a personal interest in the potential customer.
13. Personally contact the FSBO/seller or contact via mail, e-mail or telephone to present an offer.
14. Offer the FSBO/seller a grant of royalty free access to the Web pages that advertise the property and give him/her a limited right to post content on the Web pages for a specified time.
15. Anyone searching the Web who puts in the address of the FSBO house will get the Web site as a hit.

Those skilled in the art understand that this technique may be used to sell or market other properties. All that is required is a primary domain name and a set of subdomain names that are unique to the marketed items. For example, one could sell intellectual property, such as patents, by using their serial patent numbers as the unique subdomain name with a primary domain name, such as:

USPatent No9000000.patentsrus.com. Any product that has a serial number could be identified with the serial number as a subdomain name.

The invention may also be used to display and advertise automobiles for sale. An operator could use the license plate or the VIN as a unique subdomain name and attach that unique subdomain to another subdomain name descriptive of the automobile. For example a 1957 Chevrolet could be advertised as www.55577787871957Chevy.carsale.com. There the seller's home telephone number (555 777 8787) precedes the identity of the automobile (1957 Chevy) and the web page is a subdomain of the primary domain www.carsale.com. Other articles could be offered for sale by using a two or more sub-subdomain names. For example, usedcomputer.123MapleStreet14614.Clifford.com would identify a used computer for sale at the location of 123 Maple Street in Rochester, N.Y. The ZIP code 14614 corresponds to Rochester, N.Y.

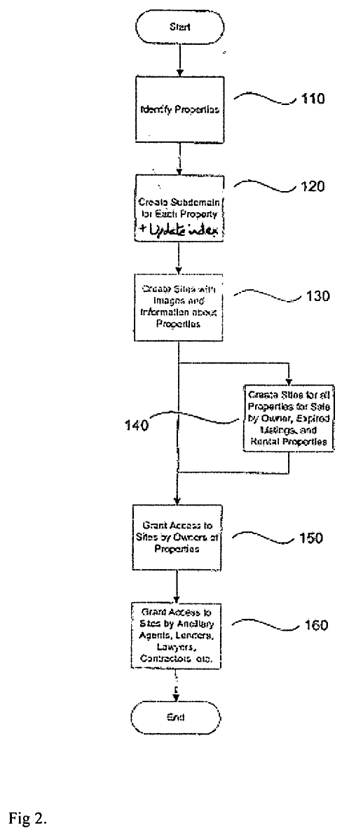

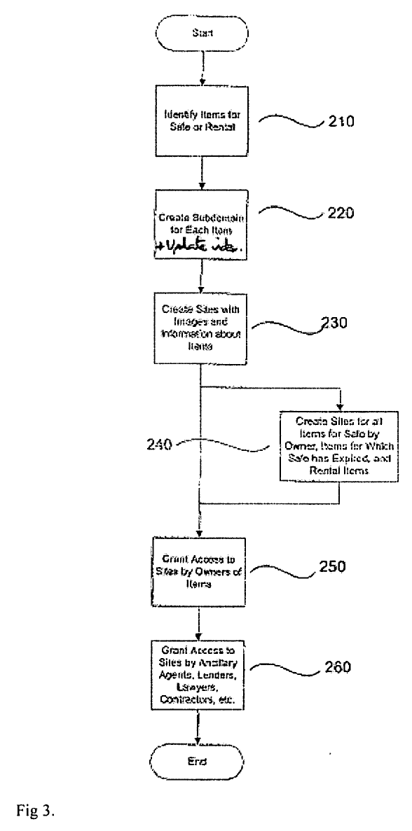

To summarize, the invention may be used to market any property, product or service, as shown in FIG. 3. The agent would grant the seller a royalty free limited time license to a pre-established vanity web site that uniquely identified the property, goods, or service. The process is the same as in FIG. 2. First is identification (step 210) of the property, goods, or services to be made available. Next is creation (step 220) of the subdomain for each item. Third is creation of presentation information (step 230) such as images and copy for each item, to be mounted for viewing on the subdomain site. Fourth is the opening or granting of access for update (step 250) by the owners or providers of the items. Fifth is the granting of access to supporting professionals or organizations (step 260). The creation of sites for date-expired items (step 240) is an optional step.

The use of subdomain names in the manner of the invention provides a more direct connection between buyers and sellers in the online marketplace than the usual commercial Websites allow. The invention constitutes a form of disintermediation, allowing the buyer to make direct contact with the seller and eliminate the usual layers of agents, distributors, salespeople, and others ordinarily involved in business transactions. Commercial search engines, no matter how well-managed, are frequently inundated with information that forces deserving locations lower on their search results. The invention also disintermediates the shopping process in that it allows the buyer to bypass the use of commercial search engines to locate goods or services for sale. This has a side benefit of allowing mobile users on the road to automatically find locations. For example, a user using an internet enabled cellphone can type in MainStRochesterNY.domain.com in order to automatically find a listing of items for sale at Main Street in Rochester, close to his location, and without the use of an external navigator such as a Global Positioning Navigation Aid.

Those skilled in the art may implement this invention by using one or more known techniques. For example, one may wish to assign and manage domain names to assign a custom Web page name to a client in a computer system, as is disclosed in U.S. Pat. No. 6,687,746, System Apparatus and Method for Hosting and Assigning Domain Names on a Wide Area Network, Shuster et al., whose entire disclosure is hereby incorporated by reference. A related technique is known to automate redirection of entered Web page names to specific known domain and subdomain names, as is disclosed in U.S. Pat. No. 6,442,602, System and Method for Dynamic Creation and Management of Virtual Subdomain Addresses, Choudhry. Its disclosure is also incorporated by reference. Such techniques may constitute one or more parts to the inventive process which specifically targets classes of business for which subdomain names map naturally onto the products and services of the business, and vice versa.

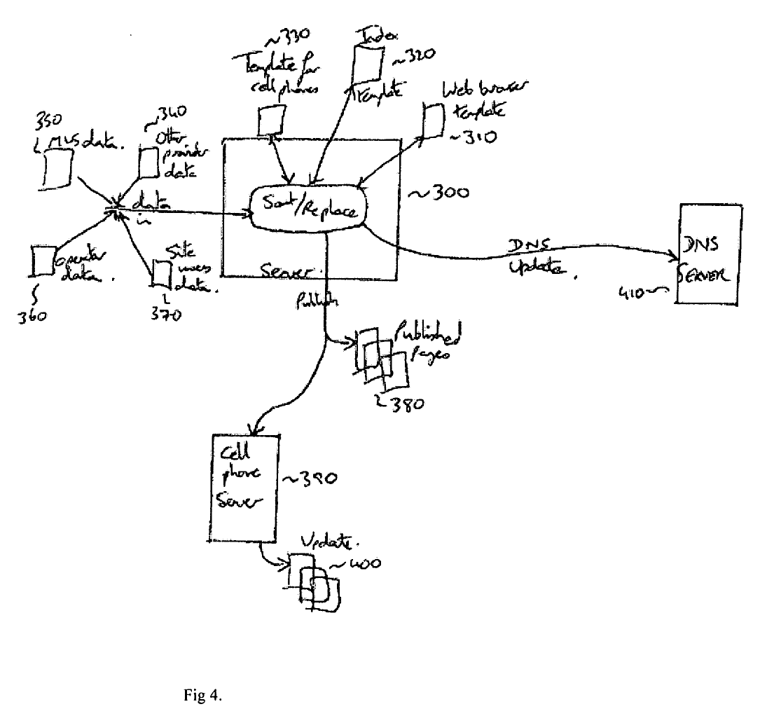

FIG. 4 demonstrates how the system can automatically generate subdomains and pages for multiple devices using multiple data sources. The system may use existing data from an operator 360 with a data entry system or from site users 370 using a web based interface either with cgi, php, asp or some other dynamic scripting language, or XML and other binary formatted data from other websites or providers 340, or MLS listing in XML and other formats from multiple MLS sites 350. Such data are entered and processed by the server 300. The server 300 then accesses templates for cell phones or other mobile devices 330 and web browsers 310 and publishes the result 380. The server can then update the DNS server for subdomain registration 410 and the index 320 which allows subdomains such as RochesterNY.domain.com to function as an aggregate index of all properties within the geographic area denoted by the subdomain. Cell phone and mobile device specific webpages can be published to the cell phone webserver 390 synchronously which can then update its existing stored published pages 400 allowing mobile users to access the same data at the same time in a format optimized for mobile devices in order to fit the limited bandwidth and screen size limitations inherent in mobile devices.

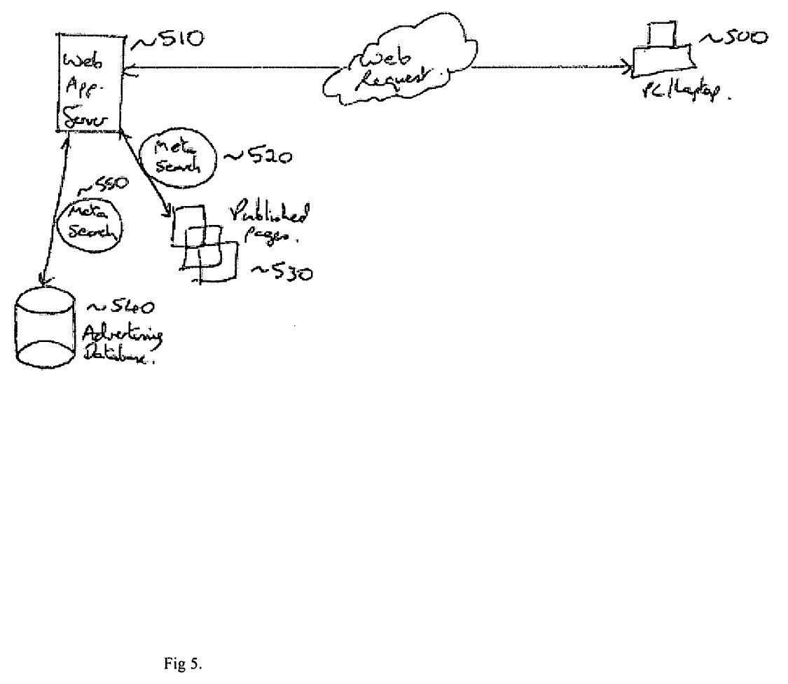

FIG. 5 demonstrates the targeted advertising model used. Using existing metadata from the published pages 530, when a request for a subdomain is entered by a user 500, the server 510 pulls the existing page from the pool 530 and does a meta search 520 which generates metadata sequences used to search the advertising database 540 and pull advertising services closely related to the users page request using a meta search and compare 550 which is used by the server to create and push the page to the user 500, along with the targeted advertising found using the meta search 550. Of course, fuzzy logic based comparison could be used along with other well-known techniques such as categorical matches and region matches to expand the potential advertiser pool and increase revenue generation. Meta data could be keyword based or even audio/video clips or any data segment with which a potential match could be made. For example, a temporal match using the status of the property (for-sale, pending sale, sold) could be used to target and display different advertisements (i.e. for lawyers during for-sale or for new home inspections and warranty services after the property is sold) based on the metadata rules in the system and the technique used for completing the match.

The invention may be used to market any property, including and not limited to real property, tangible property (e.g. cars, boats, machines) or intangible property (e.g. patents, mortgages, loans, accounts receivable, currency) or services (car rental, real estate rental, legal advice, doctors). The agent would grant the seller a royalty free limited time license to a pre-established vanity web site that uniquely identified the property, goods, or service. Virtually any real, tangible or intangible property, or service could be marketed in this way. The method could be applied to expired real estate listings, weddings (use bride and groom names) pets or licensed professionals.

What is claimed is:

1. A method for displaying one or more items on a network where the network has a plurality of unique domain names, comprising the step of establishing a subdomain with a unique identifier for each item corresponding to the description and type of the item and distinguishing said item from other similar items.

2. The method of claim 1 wherein the items displayed are for sale, lease, sublease, rent, loan or transfer.

3. The method of claim 1 wherein the items comprises one or more of the group consisting of real property, tangible property, intangible property and services.

4. The method of claim 1 wherein the unique identifier is a serial number or another unique identification number marking the item.

5. The method of claim 1 further comprising identifying one or more items in a group of items and establishing a subdomain having a subdomain identifier comprising the unique identifier of each item.

6. The method of claim 1 further comprising identifying one or more items in a group of items and establishing a subdomain having one or more indices.

7. The method of claim 6 wherein the indices are defined as a listing of items belonging to a subset of an index identifier.

8. The method of claim 1 further comprising identifying one or more items in a group of items that are listed for sale and establishing a subdomain having a subdomain identifier comprising the unique identifier of each listed item for sale.

9. The method of claim 8 wherein the subdomain further comprises one or more indices.

10. The method of claim 1 further comprising identifying one or more items in a group of items that are listed for sale by an owner or an agent of the owner of the items and establishing a subdomain having a subdomain identifier comprising the unique identifier of each listed item for sale by its owner.

11. The method of claim 10 wherein the subdomain further comprises one or more indices.

12. The method of claim 1 further comprising identifying one or more items in a group of items that are listed for sale and establishing a subdomain having a subdomain identifier comprising the unique identifier of each listed item for sale.

13. The method of claim 12 wherein the subdomain further comprises one or more indices.

14. The method of claim 1 further comprising identifying one or more items in a group of items previously listed for sale for which said listing for sale has expired, and establishing a subdomain having a subdomain identifier comprising the unique identifier of each listed item whose listing has expired.

15. The method of claim 14 wherein the subdomain further comprises one or more indices.

16. The method of claim 1 further comprising identifying one or more items in a group of items that are available for rent and establishing a subdomain having a subdomain identifier comprising the unique identifier of each listed item available for rent.

17. The method of claim 16 wherein the subdomain further comprises one or more indices.

18. The method of claim 1 further comprising the step of establishing one or more sites on a network wherein each established site corresponds to one of said subdomains and carries images and information about said items.

19. The method of claim 18 further comprising allowing owners or agents of the owners of the items access to said network sites and the authority to post images and information on the sites that correspond to the items displayed on said sites.

20. The method of claim 1 further comprising allowing others to advertise on said site(s).

21. The method of claim 20 wherein the others comprises one or more persons or entities interested in selling products or providing services or information relating to the kinds of items displayed.

22. The method of claim 21 wherein the others are advertisers and are one or more of a group consisting of aggregators, sale brokers, auctioneers, banks, credit unions, lenders, attorneys, and vendors of other services ancillary to buying or selling.

23. A method for advertising a property for sale on a network where the network has a plurality of unique domain names, comprising the step of establishing a subdomain with a unique identifier for the property corresponding to the street address of said property and distinguishing said property from properties in other regions with similar street addresses.

24. The method of claim 23 wherein the unique identifier is a street address corresponding to real property.

25. The method of claim 23 further comprising identifying one or more properties in a regional area and establishing a subdomain with the address of each property.

26. The method of claim 23 further comprising identifying one or more properties in a regional area that are listed for sale and establishing a subdomain with the address of each listed property for sale.

27. The method of claim 23 further comprising identifying one or more properties in a regional area that are listed for sale by owner and establishing a subdomain with the address of each listed property for sale by owner.

28. The method of claim 23 further comprising identifying one or more properties in a regional area that are listed for sale and establishing a subdomain with the address of each listed property for sale.

29. The method of claim 23 further comprising identifying one or more properties in a regional area that were listed for sale and said listing has expired and establishing a subdomain with the address of each property whose listing has expired.

30. The method of claim 23 further comprising identifying one or more properties or apartments in a regional area that are available for rent and establishing a subdomain with the address of each identified property available for rent.

31. The method of claim 23 further comprising the step of establishing one or more sites on a network wherein each established site corresponds to one of said subdomains and carries images and information about said property.

32. The method of claim 23 further comprising allowing the owners of the properties access to said network sites and the authority to post images and information on the sites that correspond to the property of said owners.

33. The method of claim 23 further comprising allowing others to advertise on said site(s).

34. The method of claim 33 wherein the advertisers are one or more of a group consisting of mortgagors, mortgage brokers, lending agencies, banks, credit unions, lenders, attorneys, housing inspectors, contractors for home and property repair, and vendors of other services ancillary to buying or selling real estate.
